(19) United States
(12) Patent Application Publication
(10) Pub. No.: US 2013/0242844 A1
(43) Pub. Date: Sep. 19, 2013

(54) ACCESS POINT COMMUNICATION BASED ON UPLINK TRANSMISSION

(71) Applicant: QUALCOMM INCORPORATED, San Diego, CA (US)

(72) Inventors: Damanjit Singh, San Diego, CA (US); Peerapol Tinnakornsrisuphap, San Diego, CA (US); Mehmet Yavuz, San Diego, CA (US)

(73) Assignee: QUALCOMM Incorporated, San Diego, CA (US)

(21) Appl. No.: 13/787,639

(22) Filed: Mar. 6, 2013

Related U.S. Application Data
(60) Provisional application No. 61/612,069, filed on Mar. 16, 2012.

(51) Int. Cl. H04W 72/04

(52) U.S. Cl. CPC H04W 72/0426
USPC 370/312; 370/329

(57) ABSTRACT

Uplink transmissions by an access terminal are used to communicate information from one access point to another access point. For example, a first access point that is serving an access terminal and wishes to communicate certain information to a second access point configures the access terminal to conduct an uplink transmission using a specified physical layer parameter. The specified physical layer parameter is different from the physical layer parameter normally used by the access terminal for uplink transmissions to the first access point. The second access point monitors for uplink transmissions that are based on the specified physical layer parameter. Detection of an uplink transmission (based on the specified physical layer parameter) by the second access point results in the information being conveyed to the second access point.

### CLAIM OF PRIORITY

This application claims the benefit of and priority to commonly owned U.S. Provisional Patent Application No. 61/612,069, filed Mar. 16, 2012, and assigned Attorney Docket No. 121773P1, the disclosure of which is hereby incorporated by reference herein.

### BACKGROUND

1. Field

This application relates generally to wireless communication and more specifically, but not exclusively, to access point communication based on uplink transmission by an access terminal.

2. Introduction

A wireless communication network may be deployed over a defined geographical area to provide various types of services (e.g., voice, data, multimedia services, etc.) to users within that geographical area. In a typical implementation, access points (e.g., corresponding to different cells) are distributed throughout a network to provide wireless connectivity for access terminals (e.g., cell phones) that are operating within the geographical area served by the network.

In some networks, low-power access points are deployed to supplement conventional network access points (e.g., macro access points). For example, a low-power access point installed in a user's home or in an enterprise environment (e.g., commercial buildings) may provide voice and high speed data service for access terminals supporting cellular radio communication (e.g., CDMA, WCDMA, UMTS, LTE, etc.). In general, these low-power access points provide more robust coverage and higher throughput for access terminals in the vicinity of the low-power access points.

Low-power access points are generally deployed on an ad-hoc basis, without strict operator network control. In a typical scenario, an individual user deploys a low-power access point in the user's home or office without regard to any other access points in the vicinity.

Moreover, it may be difficult or impractical for a given low-power access point to identify and communicate with all of its neighbor low-power access points. For example, other relatively nearby low-power access points may be “hidden” from (e.g., not detectable by) a first low-power access point, but visible to (e.g., detectable by) an access terminal within the coverage of the first low-power access point.

In practice, however, it may be desirable for a given low-power access point to be aware of and communicate with its neighbor access points. For example, access points in communication may coordinate on selection parameters such as transmit power and physical layer identifiers and may share identifiers, paging area codes, or other information. In this way, the access points may cooperate to improve service in the area, mitigate interference between access points, facilitate handover of access terminals between access points, and so on. In view of the above, there is a need for effective techniques for enabling communication between access points.

### SUMMARY

A summary of several sample aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to a communication scheme where an access point uses uplink transmissions from an access terminal to communicate with another access point. For example, a first access point may send a message to an access terminal to cause the access terminal to send certain information via uplink transmissions. A second access point in the vicinity of the access terminal configured to monitor for such transmissions is thus able to receive the information. Accordingly, an access point may use uplink transmissions by an access terminal to communicate with other access points that are hidden from the access point, or to communicate with other neighboring access points, in general.

In some aspects, the communication scheme involves the first access point configuring the access terminal to use, for the uplink transmission, a physical layer parameter that will be monitored by the second access point. In this scenario, the first access point is the serving access point for the access terminal. In addition, the access terminal initially uses a first physical layer parameter terminal for uplink transmissions to the first access point.

When the first access point wishes to communicate certain information to the second access point, the first access point configures the access terminal to conduct an uplink transmission using a second physical layer parameter. Of note, the second physical layer parameter is different from the first physical layer parameter. Moreover, the second access point is configured to monitor for uplink transmissions that are based on the second physical layer parameter. A mapping between the second access point and the physical layer parameter(s) monitored by the second access point is made available to other access points in the wireless system (e.g., by operator provisioning). Typically, this mapping is based on the identity of the second access point. For example, access point identifiers may be mapped to corresponding uplink physical layer parameters. Hence, upon determining the identity of the second access point, the first access point is able to select the second physical layer parameter knowing that uplink transmission that use the second physical layer parameter should be detected by the second access point.

Detection of an uplink transmission based on the second physical layer parameter by the second access point thus results in the information being conveyed to the second access point. In some implementations, the value of the second physical layer parameter conveys certain information. In some implementations, the information (e.g., a message) is conveyed via the uplink transmission by the access terminal (e.g., the information is encoded using the second physical layer parameter).

In view of the above, in some aspects, wireless communication in accordance with the teachings herein involves: determining that a first access point is to communicate with a second access point via uplink transmissions by an access terminal served by the first access point; selecting, as a result of the determination, a physical layer parameter for the uplink transmissions by the access terminal; and invoking the communication by sending a message from the first access point to the access terminal, wherein the message includes the physical layer parameter.

In addition, in some aspects, wireless communication in accordance with the teachings herein involves: identifying, at an access point, a physical layer parameter for receiving a signal from an access terminal that is not being served by the access point; using the physical layer parameter to receive the signal; and selecting at least one operation to be performed at the access point based on the identified physical layer parameter.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of a sample communication system supporting inter-access point communication;

FIG. 2 is a flowchart of several sample aspects of operations that may be performed in conjunction with providing inter-access point communication;

FIGS. 3, 4, and 5 are simplified diagrams illustrating an example of signaling between access points and an access terminal;

FIG. 6 is a flowchart of several sample aspects of operations that may be performed at an access point that invokes uplink signaling by an access terminal to communicate information to another access point;

FIG. 7 is a flowchart of several sample aspects of operations that may be performed at an access point to select an operation to be performed based on an uplink signal received from an access terminal that is not served by the access point;

FIG. 8 is a simplified block diagram of several sample aspects of components that may be employed in communication nodes;

FIG. 9 is a simplified diagram of a wireless communication system;

FIG. 10 is a simplified diagram of a wireless communication system including femto nodes;

FIG. 11 is a simplified diagram illustrating coverage areas for wireless communication;

FIG. 12 is a simplified block diagram of several sample aspects of communication components; and

FIGS. 13 and 14 are simplified block diagrams of several sample aspects of apparatuses configured to facilitate uplink-based inter-access point communication as taught herein.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, any aspect disclosed herein may be embodied by one or more elements of a claim.

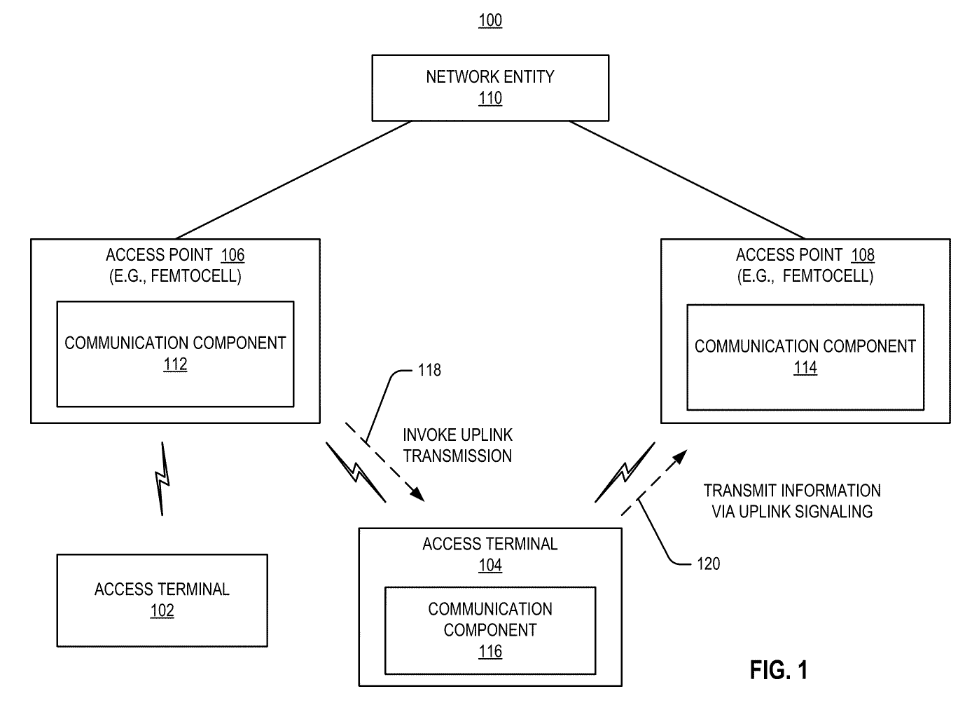

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, macrocells, femtocells, and so on, while access terminals may be referred to or implemented as user equipment (UEs), mobile stations, and so on.

Access points in the system 100 provide access to one or more services (e.g., network connectivity) for one or more wireless terminals (e.g., access terminals 102 and 104) that may be installed within or that may roam throughout a coverage area of the system 100. For example, at various points in time the access terminal 102 may connect to an access point 106, an access point 108, or some access point in the system 100 (not shown). Similarly, at various points in time the access terminal 104 may connect to the access point 106, the access point 108, or some access point.

Each of the access points may communicate with one or more network entities (represented, for convenience, by a network entity 110), including each other, to facilitate wide area network connectivity. Two or more of such network entities may be co-located and/or two or more of such network entities may be distributed throughout a network.

A network entity may take various forms such as, for example, one or more radio and/or core network entities. Thus, in various implementations the network entity 110 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

As indicated in FIG. 1, some of the access points (e.g., the access points 106 and 108) in the system 100 comprise low-power access points. Various types of low-power access points may be employed in a given system. For example, low-power access points may be implemented as or referred to as femtocells, femto access points, small cells, femto nodes, home NodeBs (HNBs), home eNodeBs (HeNBs), access point base stations, picocells, pico nodes, or microcells. Typically, low-power access points connect to the Internet via a broadband connection (e.g., a digital subscriber line (DSL) router, a cable modem, or some other type of modem) that provides a backhaul link to a mobile operator's network. Thus, a low-power access point deployed in a user's home or business provides mobile network access to one or more devices via the broadband connection.

As used herein, the term low-power access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in the coverage area. In some implementations, each low-power access point has a transmit power (e.g., as defined above) that is less than a transmit power (e.g., as defined above) of the macro access point by a relative margin (e.g., 10 dBm or more). In some implementations, low-power access points such as femtocells may have a maximum transmit power of 20 dBm or less. In some implementations, low-power access points such as picocells may have a maximum transmit power of 24 dBm or less. It should be appreciated, however, that these or other types of low-power access points may have a higher or lower maximum transmit power in other implementations (e.g., up to 1 Watt in some cases, up to 10 Watts in some cases, and so on).

For convenience, low-power access points may be referred to simply as femtocells or femto access points in the discussion that follows. Thus, it should be appreciated that any discussion related to femtocells or femto access points herein may be equally applicable to low-power access points in general (e.g., to picocells, to microcells, to small cells, etc.).

Femtocells may be configured to support different types of access modes. For example, in an open access mode, a femtocell may allow any access terminal to obtain any type of service via the femtocell. In a restricted (or closed) access mode, a femtocell may only allow authorized access terminals to obtain service via the femtocell. For example, a femtocell may only allow access terminals (e.g., so called home access terminals) belonging to a certain subscriber group (e.g., a closed subscriber group (CSG)) to obtain service via the femtocell. In a hybrid access mode, alien access terminals (e.g., non-home access terminals, non-CSG access terminals) may be given limited access to the femtocell. For example, a macro access terminal that does not belong to a femtocell's CSG may be allowed to access the femtocell only if sufficient resources are available for all home access terminals currently being served by the femtocell.

In a typical deployment model, femtocells operating in one or more of these access modes are used to provide indoor coverage and/or extended outdoor coverage. By allowing access to users through adoption of a desired access mode of operation, femtocells may provide improved service with the coverage area and potentially extend the service coverage area for users of a macro network.

Under certain circumstances, an access point such as a femtocell may need to communicate with another such access point. For example, the access point 106 may need to communicate with the access point 108 to facilitate handover of the access terminal 104 or to mitigate interference in the neighborhood. However, communication through the backhaul (e.g., via the network entity 110) may be impractical (e.g., too burdensome on the core network) or impossible in some cases. For example, the access point 106 may not have access to sufficient information (e.g., address information) to enable communication with the access point 108 via the backhaul.

The disclosure relates in some aspects to using uplink transmission by an access terminal (e.g., a UE) to communicate information from one access point to another access point. For example, uplink transmissions by an access terminal being served by a given femtocell may be used for communicating with femtocells that are hidden from that serving femtocell, or for communicating with other neighboring femtocells, in general. To this end, the access point 106, the access point 108, and the access terminal 104 are depicted in FIG. 1 as including a communication component 112, a communication component 114, and a communication component 116, respectively. For example, to convey certain information to the access point 108, the communication component 112 sends a signal 118 to invoke an uplink transmission by the access terminal 104. Upon receipt of the signal 118 by the access terminal 104, the communication component 116 transmits an appropriate uplink signal 120 conveying the information. Upon detecting the uplink signal 120, the communication component 114 determines the information being conveyed by the signal 120.

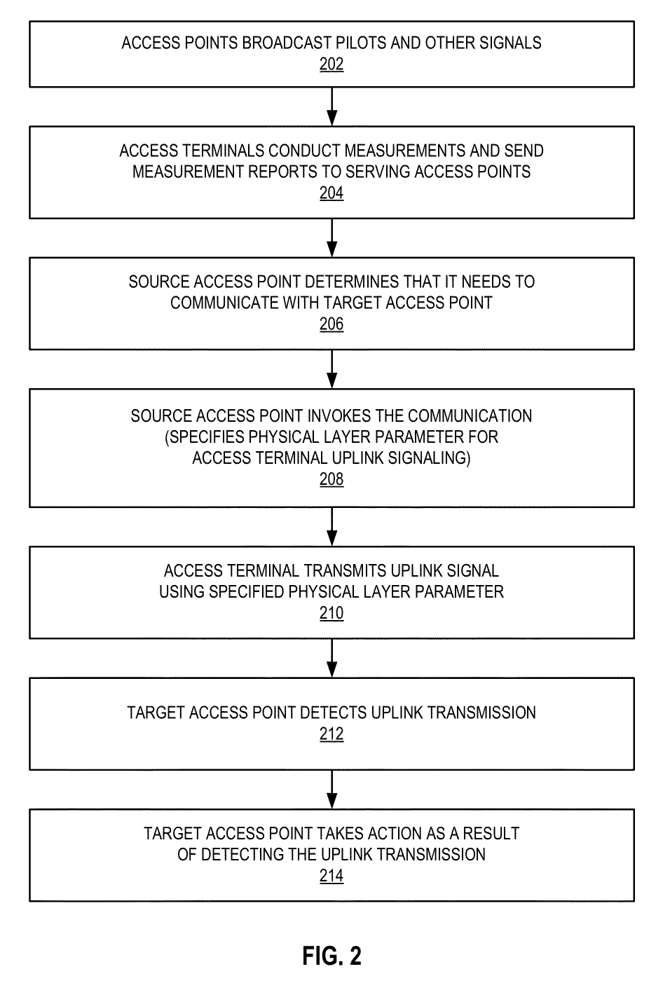

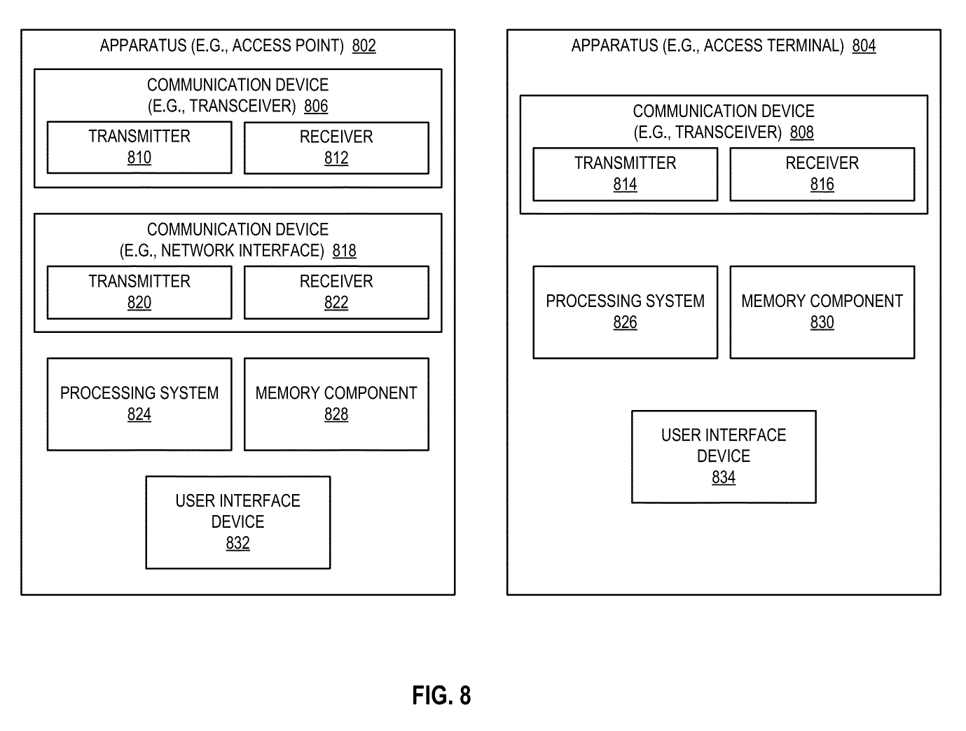

Sample aspects of an uplink transmission-based communication scheme will now be described in more detail in conjunction with the flowchart of FIG. 2. For purposes of illustration, the operations of FIG. 2 (or any other operations discussed or taught herein) may be described as being performed by specific components (e.g., components of FIG. 1 or FIG. 8). In addition, these operations may be described in the context of a UMTS system or an LTE system. It should be appreciated, however, that these operations may be performed by other types of components and may be performed using a different number of components, and that the teachings herein are applicable to other types of communication systems. It also should be appreciated that one or more of the operations described herein might not be employed in a given implementation.

In the discussion that follows, an access point initiating a communication is referred to as the source access point, while an access point to which the communication is directed is referred to as the target access point. Thus, the terms source and target do not necessarily refer to a handover source and target. These access points also may be referred to herein as the first and second access points, or vice versa.

As represented by block 202 of FIG. 2, each of the access points in a given neighborhood of a system transmit pilots and other similar signals using one or more broadcast parameters. Preferably, although not always, each access point uses a set of one or more broadcasts parameters that is unique within that neighborhood. In this way, different access points can be distinguished from one another based on their broadcast parameter(s). For example, in UMTS each access point may broadcast a pilot signal coded by a primary scrambling code (PSC). In this case, the identity of the access point that broadcasts a given pilot signal may be determined based on the corresponding PSC. Depending on the wireless technology, each access point may broadcast other information such as a location area code (LAC), a routing area code (RAC), a tracking area code (TAC), a physical cell identity (PCI), or a cell identifier.

As represented by block 204, each access terminal in the system will conduct measurements to identify any access points in the vicinity and report the results of these measurements to the access terminal's serving access point. For example, for a given access point, an access terminal may detect the information broadcast by the access point, measure the received signal strength of the signals from the access point, and determine timing of the access point relative to the access terminal (e.g., an observed time difference (OTD)).

The access terminal then sends a measurement report message to its serving access point to report the broadcast parameters, received signal strength information, and timing information. Accordingly, access points in the system may discover the existence and identity of other relatively nearby access points. Since a measurement report includes information measured by an access terminal, an access point may even discover the identity of access points that cannot be heard by the access point (assuming the access point even includes the capability to listen for neighboring access points).

As represented by block 206, at some point in time, a source access point may determine that it needs to communicate with at least one other access point. For example, a target access point may be interfering with reception at an access terminal being served by the source access point. Accordingly, the source access point may send a request to the target access point to change one or more of its transmission parameters (e.g., transmit power, channel, etc.). As another example, the source access point may detect identifier confusion (e.g., two access points using the same PSC). In this case, the source access point may report this confusion to its neighboring access points so that one or more of those access points (i.e., at least one of the access points broadcasting the identifier) can take action to eliminate the confusion. As another example, the source access point may wish to communicate with a target access point to facilitate handover of one or more access terminals. For example, the source access point may wish to encourage the target access terminal to accept a handover from the source access point.

As discussed herein, such inter-access point communication may not always be possible over the backhaul. The source access point may thus advantageously employ uplink-based transmission by one of its access terminals to communicate with a neighboring access point in accordance with the teachings herein.

In support of this communication scheme, access points in the system are configured to monitor for uplink signals not only from their served access terminals, but also from access terminals that they are not serving. In particular, a range of physical layer parameters may be designated for this purpose in the system. Moreover, different subsets (one or more) of these physical layer parameters may be associated, in a mutually exclusive manner, with one or more parameters associated with the access point (e.g., configuration parameters that serve to identify the access point). For example, a first subset of the physical layer parameters may be associated with a first configuration parameter (e.g., an identifier of a first access point), a second subset of the physical layer parameters may be associated with a second configuration parameter (e.g., an identifier of a second access point), and so on. In this way, once the source access point knows the identity (e.g., the configuration parameter(s)) of a target access point, the source access point may direct a communication to that specific target access point through the selection of the appropriate physical layer parameter(s) for uplink signaling.

The physical layer parameters may take different forms in different wireless technologies. For example, the physical layer parameters may comprise uplink scrambling codes in UMTS. As another example, the physical layer parameters may relate to random access channel (RACH) parameters in LTE. In some aspects, the RACH parameters specify different codes and different timeslots that may be used for uplink transmissions. In some aspects, RACH is associated with physical layer RACH and transport layer RACH. Thus, in LTE, the selection of uplink parameters may comprise selecting at least one physical layer parameter and at least one transport layer parameter.

A configuration parameter that serves to identify a source access point also may take various forms. For example, the configuration parameter(s) may include one or more of: a PSC, a cell identifier, a location area code (LAC), or a routing area code (RAC).

As represented by block 208 of FIG. 2, to invoke the communication to the target access point, the source access points transmits a message to one of its serving access terminals requesting that the access terminal transmit an uplink signal using a specific physical layer parameter. The actual information conveyed to the target access point may be included in the message or, preferably in some cases, indicated by the specified physical layer parameter.

As an example of the latter scenario, different physical layer parameters may be mutually exclusively associated with different types of information. For example, a first type of communication may be associated with a first physical layer identifier, a second type of communication may be associated with a second physical layer identifier, and so on. In this way, once the source access point knows the subset of physical layer identifiers associated with a given target access point, the source access point may direct a specific type of communication to that target access point through the selection of the appropriate physical layer parameter.

Several examples of information that may be communicated in this manner follow. Where applicable, different values associated with a given type of information (e.g., overloaded versus underloaded; or actual load values) may be indicated by different physical layer parameters and/or by information transmitted in conjunction with the message from the source access point to the access terminal. One or more of the following types of information may be communicated during a given communication (e.g., by appropriate mapping to the physical layer parameter selected for the uplink transmission).

In some implementations, the communicated information comprises load information for a source access point. The load information may relate to, for example, loading on a radiofrequency (RF) channel, loading on the backhaul, available transmit power, and so on. A source access point may send such information, for example, to inform the target access point that the source access point is overloaded. In this way, the source access point may be able to encourage handover of one or more access terminals to the target access point and/or discourage handovers from the target access point.

In some implementations, the communicated information comprises at least one capability supported by a source access point. This capability may relate to, for example, backhaul bandwidth, maximum transmit power, and so on. A source access point may send such information, for example, to inform the target access point that the source access point either does or does not have the capability to accept handovers from the target access point. Similarly, this information may be sent to encourage or discourage handovers to the target access point.

In some implementations, the communicated information comprises availability of at least one resource of the source access point. The at least one resource may comprise, for example: channel elements and/or backhaul bandwidth. A source access point may send such information, for example, to inform the target access point that the source access point either does or does not have the resources available to accept handovers from the target access point. Similarly, this information may be sent to encourage or discourage handovers to the target access point.

In some implementations, the communicated information comprises an indication of physical layer (e.g., PSC) confusion in a neighborhood of the source access point. This indication may optionally specify the physical layer parameter that is subject to confusion.

In some implementations, the communicated information comprises an indication to commence transmission on (e.g., of) a specified channel. The transmission on a specified channel may comprise, for example, transmitting on another common pilot channel (CPICH) with another physical layer parameter (e.g., PSC). Such an indication may comprise, for example, a request to the target access point to commence transmission on the specified channel or a notification that the source access point will commence transmission on the specified channel. A source access point may send such information, for example, in the event another channel is experiencing an unacceptable level of interference.

In some implementations, the communicated information comprises a request to change at least one parameter at the target access point. The at least one parameter may relate to, for example, at least one of: a primary scrambling code (PSC), a physical cell identity (PCI), a random access channel (RACH) parameter, a location area code (LAC), a routing area code (RAC), a tracking area code (TAC), a closed subscriber group identifier (CSG ID), a CSG Indicator, a SIB schedule, invoking transmission of an additional SIB, a transmit power, an access restriction, or an access mode. A source access point may send such a request, for example, in an attempt to mitigate interference, mitigate identifier confusion, or facilitate handover.

In some implementations, the communicated information comprises a request to turn off the target access point. For example, the request may ask the target access point to turn off its transmitter for a specified period of time. A source access point may send such a request, for example, to temporarily stop interference caused by the target access point.

In some implementations, the communicated information comprises a request to reboot the target access point. For example, the request may ask the target access point to reboot itself as soon as possible. A source access point may send such a request, for example, to bring the target access point back into service.

In some implementations, the communicated information comprises a request to the target access point to accept handover of an access terminal. Accordingly, this request may include information about the access terminal, the current session for the access terminal, and any other information needed to conduct the handover.

In some implementations, the communicated information comprises an alarm indication at the source access point. The alarm indication may relate to, for example, at least one of: temporary inability to accept additional users (i.e., users' access terminals), possibility of shut down, or loss of backhaul.

Referring now to block 210 of FIG. 2, upon receipt of the message from the source access point, the access terminal transmits an uplink signal using the specified physical layer parameter. In cases where the physical layer identifier indicates the information being sent to the second access point, the uplink signal need not include real data. Conversely, in cases where the source access point sends the access terminal information to be forwarded to the target access point, the access terminal may include this information in the uplink signal (or transmit it in another message).

As mentioned above, the target access point listens to (e.g., monitors) certain uplink transmissions that may be sent by an access terminal that is not being served by the target access point. For example, in UMTS, a target access point may monitor certain uplink scrambling codes. As mentioned above, the uplink scrambling code(s) to be monitored by a given target access point may be based on, for example, one or more parameters (e.g., PSC, PCI, cell identity, LAC, TAC, or RAC) associated with the target access point.

To assist a target access point in detecting the uplink transmissions by an access terminal, the timing of these uplink transmissions may be controlled in some aspects by the source access point. For example, the source access point may use a DOFF (dedicated physical downlink channel (DPDCH) Offset) parameter to ensure that transmission of the specific uplink scrambling code is within 512 chips of the target cell's CPICH timing. As discussed above, the access terminal may report the target access point's timing via an observed time difference (OTD) parameter included in the access terminal's measurement report. The source access point may thus control when the access terminal conducts the uplink transmission (e.g., by adjusting the timing of the access terminal). In some implementations (e.g., where some form of communication has been established between the access points), the timing of the transmission of the uplink signals may be pre-negotiated between the access points.

As represented by block 212, as a result of the monitoring, the target access point detects the uplink transmission (e.g., detects energy on a monitored uplink scrambling code). The target access point may then identify the information being communicated (e.g., based on the particular uplink scrambling code or based on information transmitted in conjunction with the uplink scrambling code).

As represented by block 214, the target access point then takes appropriate action based on the communicated information. Several examples of actions that may be taken (e.g., operations performed) by a target access point follow. One or more of the following types of operations may be performed in response to a given communication. For example, the operation(s) to be performed may be indicated by appropriate mapping to the physical layer parameter (e.g., uplink scrambling code) used for the uplink transmission and, hence, appropriate mapping to the communicated information.

In some implementations, the operation performed comprises adjusting a transmit power of the target access point. The target access point may adjust its transmit power based on, for example, one or more of: loading at the source access point, capabilities of the source access point, available resources at the source access point, a request to change transmit power received from the source access point, an alarm at the source access point, and so on. As a specific example, if the target access point determines based on information received from the source access point that the source access point is not transmitting heavily (e.g., based information indicating that the source access point is underloaded, has limited resources, has limited capabilities, is shutting down because of under an alarm condition, etc.), the target access point may elect to increase its transmit power.

In some implementations, the operation performed comprises changing at least one parameter (e.g., at least one broadcast parameter) used by the target access point. For example, a broadcast parameter may be changed based on one or more of: an indication of PSC confusion, a request to commence transmission on another channel received from the source access point, a request to change a parameter received from the source access point, an alarm condition at the source access point, and so on. In some implementations, a changed broadcast parameter relates to at least one of: a primary scrambling code (PSC), a physical cell identity (PCI), a random access channel (RACH) parameter, a location area code (LAC), a routing area code (RAC), a tracking area code (TAC), a closed subscriber group identifier (CSG ID), a CSG Indicator, a SIB schedule, or invoking transmission of an additional SIB. As an example of the addition of a SIB, the source access point may request the target access point to transmit a certain information element (IE), where transmission of this IE requires the target access point to start a new SIB.

In some implementations, the operation performed comprises transmitting on another channel (e.g., a different CPICH). Such an operation may be performed, for example, based on one or more of: loading at the source access point, capabilities of the source access point, available resources at the source access point, receipt of a request to the target access point to transmit on another channel, an alarm condition at the source access point, and so on. For example, if the source access point appears to be heavily loaded or limited in capacity or resources, the target access point may elect to transmit on another channel to free up resources for the source access point. In some implementations, the transmission on the other channel comprises using another physical layer identifier (e.g., PSC).

In some implementations, the operation performed comprises changing an access restriction and/or access mode of a target access point. Such an operation may be performed, for example, based on one or more of: loading at the source access point, capabilities of the source access point, available resources at the source access point, a request to change access restriction and/or access mode, an alarm, and so on. For example, the target access point may switch to using a more permissive access restriction or access mode (e.g. switch from closed access mode to a hybrid access mode) if the source access point is overloaded (e.g. handling too many access terminals). In this way, the target access point may take on some of the load.

In some implementations, the operation performed comprises sending a message to another access point. Such an operation may be performed, for example, based on one or more of: an indication of physical layer identifier confusion, a received request, an alarm, and so on. In some implementations, the message relates to changing a physical layer parameter (e.g., PSC). In some implementations, the message relates to changing an upper layer parameter (e.g., LAC, CSG ID). In some implementations, the message relates to acknowledging monitoring of uplink transmissions from the access terminal.

In some implementations, the operation performed comprises turning off a target access point or rebooting a target access point. Such an operation may be performed, for example, based on a request to turn off or reboot that was received from the source access point.

In some implementations, the operation performed comprises accepting specified messages via a backhaul. Such an operation may be performed, for example, based on a request to receive the messages. In some implementations, the specified messages are handover-related messages.

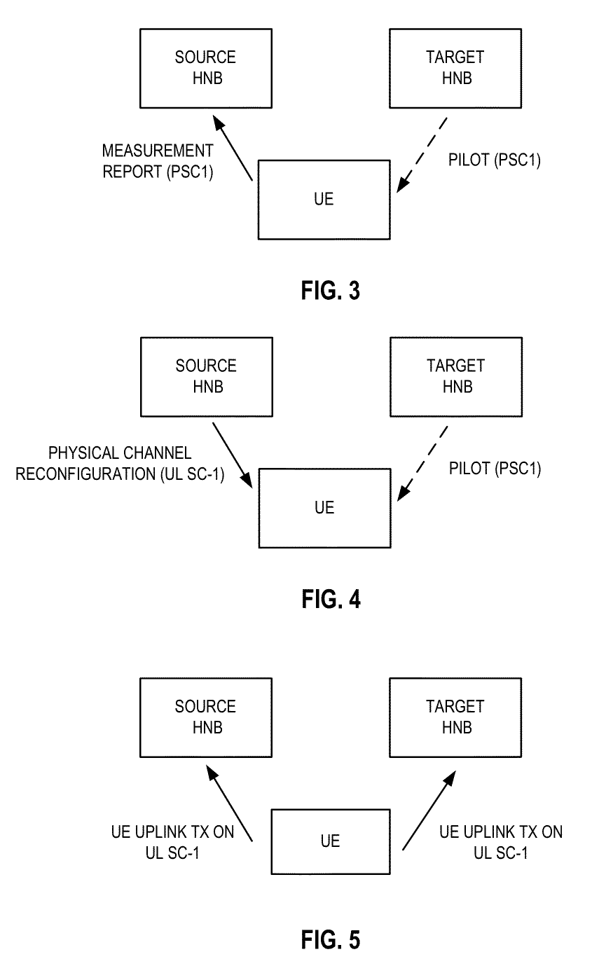

Referring now to FIGS. 3-5, an example of UMTS signaling that may be employed in an uplink transmission-based communication scheme as taught herein is described. It should be appreciated that other signaling may be employed in other implementations. In this example, the source and target access points are designated as Home NodeBs (HNBs) and the access terminal is designated as a UE.

In FIG. 3, the UE measures (e.g., detects) a pilot signal from the target HNB. This pilot signal is indicative of (e.g., is coded based on) a broadcast parameter that is used to identify the target HNB. In particular, the pilot signal is coded by a PSC (designated PSC1 in FIG. 3) used by the target HNB. The UE also may receive other signals (e.g., messages) including other broadcast parameters used by the target HNB (e.g., a cell identifier, a PCI, a LAC, a RAC, etc.).

As a result of the above measurement, the UE sends a measurement report to its serving HNB (the source HNB in this example). The measurement report includes an identifier of the target HNB to indicate that the UE has detected the target HNB. In this example, the UE reports the PSC (PSC1) used by the target HNB. As discussed herein, in some cases, the source-HNB may not otherwise be aware of the presence of the target HNB.

The measurement report may include other information about the target HNB. For example, the UE may report an OTD that the UE determines based on the timing of signals received from the target HNB. In addition, the UE may report one or more broadcast parameters that the UE received from the target HNB.

In FIG. 4, at some point in time (e.g., triggered by an event or condition at the source HNB), the source HNB determines that it needs to communicate information to the target HNB. As a result of determining that a communication to the target HNB is needed, the source HNB configures the UE with a physical layer parameter (an uplink scrambling code designated UL SC-1 in this case) that the target HNB should be monitoring. That is, as discussed herein, the selected physical layer parameter may be specific to the target HNB (e.g., based on PSC1 used by the target HNB as reported by the UE). In the example of FIG. 4, this configuration is achieved through the use of a physical channel reconfiguration message.

As discussed herein, the source HNB is thus able to communicate certain information to the target HNB. The information may be communicated in a variety of ways. In some cases, the selected physical layer parameter (e.g., UL SC) used for the uplink transmission will be indicative of the information to be transmitted. In some cases, information provided by the source HNB to the UE may be encoded by the UE within an uplink transmission.

Referring now to FIG. 5, the target HNB may listen (e.g., on a regular or continuous basis) for the appropriate UL SC. As discussed herein, the target HNB may determine the appropriate UL SC based on a parameter associated with the target HNB (e.g., a PSC).

In the example of FIGS. 3-5, the target HNB listens for UL SC-1 corresponding to PSC1. Once the UE commences uplink transmissions using UL SC-1, the target HNB detects energy on the monitored UL SC-1. Upon detecting this energy, the target HNB may take appropriate action as discussed herein.

At some point in time, the source HNB may send another physical channel reconfiguration message to the UE to instruct the UE to revert back to using the PSC that the UE previously used to communicate with the UE. In some cases, this reversion may occur a defined period of time after the physical channel reconfiguration message is sent in FIG. 4. Such an approach may be used, for example, where it may be assumed that there will not be any need to send any more information to the target HNB before the expiration of the defined period of time (e.g., the target eNB is expected to complete its operation without fail). In some cases, this reversion may occur as a result of a trigger condition. For example, the source HNB may monitor for a change in RF signaling (e.g., a detected change in the target HNB's transmit power or broadcast parameters, etc.) or receipt of a message from the UE or the target eNB indicating that the operation has completed. Once this trigger condition is met, the reversion may be invoked.

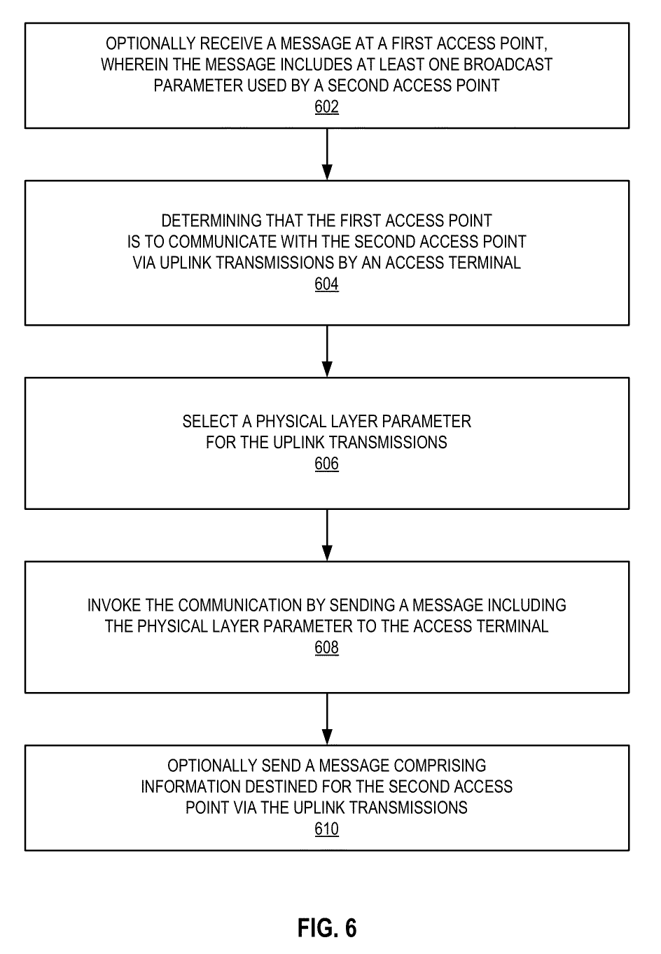

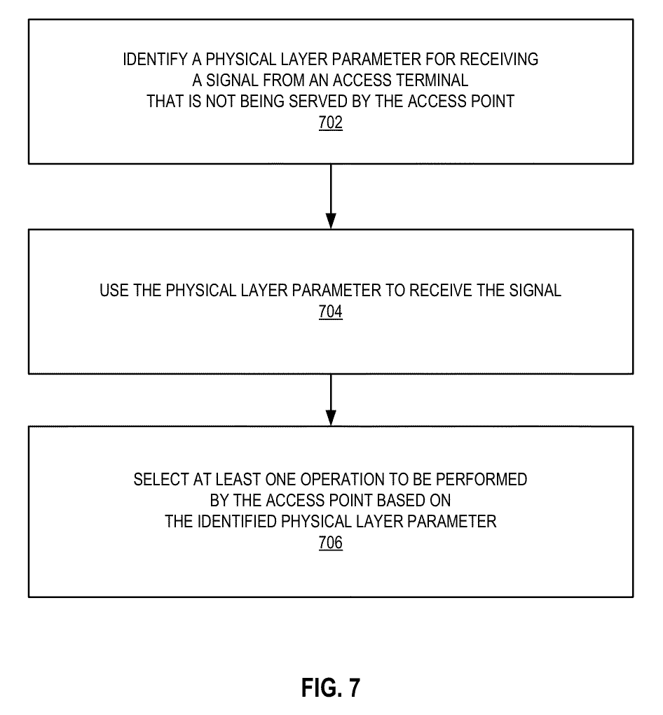

With the above in mind, additional examples of operations relating to the above will now be described in more detail in conjunction with the flowcharts of FIGS. 6 and 7.

FIG. 6 illustrates operations that may be performed, for example, by a source access point. In this example, the source access point is referred to as the first access point and the target access point is referred to as the second access point.

At some point in time, the first access point identifies a second access point with which the first access point may wish to communicate. In a typical scenario, the first access point receives a message that identifies the second access point.

For example, as represented by block 602, the first access point may receive a message that includes at least one broadcast parameter used by a second access point. As discussed above, the first access point may receive a measurement report message from an access terminal that is currently being served by the first access point. This message may indicate that the second access point has been detected by the access terminal. In a typical case, the message includes the PSC (or other similar broadcast parameter) being used by the second access point as well as other information (e.g., one or more other broadcast parameters such as a cell identifier, a LAC, a RAC, etc.) used by the second access point.

Alternatively, the first access point may select the second access point in some other manner. As a simple example, the first access point may simply select PSCs (e.g., randomly, in a defined order, etc.) and attempt to communicate with any access points that happen to use the selected PSCs.

As represented by block 604, at some point in time, the first access point determines that it is to communicate with the second access point via uplink transmissions by an access terminal served by the first access point. For example, an event or a condition at the first access point may trigger the need to communicate with the second access point. Examples of such an event or condition include: a change in available resources, loading, or capabilities; a change in operating conditions; an alarm condition; a need to reconfigure transmission parameters or channels; observed interference; or a need to handover an access terminal Advantageously, the communication may be defined to cause the second access point to take a specified action in an attempt to address the event or condition.

In some implementations, the determination that the first access point is to communicate with the second access point comprises identifying a type of information to be communicated. For example, the first access point may determine that is needs to transmit one or more of the types of information listed herein to the second access point (e.g., to cause the second access point to invoke an action or actions corresponding to the information type(s)). For example, the identified type of information may comprise one or more of: a cell identifier of the first access point, at least one operating condition of the first access point (e.g., load information, capability supported, resource availability, alarm condition), an indication of physical layer identifier confusion, or a request to the second access point (e.g., to change at least one parameter, to turn off, to reboot, to accept handover, to commence transmission on a specified channel).

As represented by block 606, as a result of the determination of block 604, the first access point selects a physical layer parameter for the uplink transmissions by the access terminal. In some implementations, the physical layer parameter is an uplink scrambling code or a RACH physical layer parameter.

In some implementations, the selection of the physical layer parameter is based on at least one broadcast parameter used by the second access point. For example, the first access point may select a physical layer parameter that is defined as being associated with the PSC that the access terminal reported (i.e., the PSC being used by the second access point). This association (e.g., a mapping) may be provisioned in the access points in a variety of ways (e.g., provisioned by the network, provisioned upon deployment, etc.).

In some implementations, the selection of the physical layer parameter is based on the identified type of information. For example, when a particular type of information is to be communicated to the second access point, the first access point may select a physical layer parameter that is defined as being associated with that particular type of information. This association (e.g., a mapping) may be provisioned in the access points in a variety of ways (e.g., provisioned by the network, provisioned upon deployment, etc.).

As represented by block 608, the first access point invokes the communication by sending (e.g., transmitting) a message including the physical layer parameter to the access terminal As discussed above, upon receiving this message, the access terminal will commence transmission of uplink signaling using the designated physical layer parameter, thereby communicating the desired information to the second access point.

Block 610 represents an alternative implementation where the first access point sends specific information that is to be transmitted to the second access point. For example, the first access point may send (e.g., transmit) a message to the access terminal, where the message includes information (e.g., the information listed above) destined for the second access point via the uplink transmissions by the access terminal. Thus, when the access terminal receives this information, the access terminal may transmit this information via uplink signaling (e.g., based on the designated physical layer parameter). In this case, the second access point may receive the information directly, as opposed to the indirect method (e.g., based on a mapping of physical layer parameter to information) described above.

FIG. 7 illustrates sample operations that may be performed, for example, by a target access point. In this example, the target access point is referred to as the access point while the source access point is referred to as the other access point.

As represented by block 702, at some point in time, the access point identifies one or more physical layer parameters (e.g., an UL SC) for receiving a signal from an access terminal that is not being served by the access point. The manner in which this is done depends on the particular implementation.

Typically, the access point identifies (e.g., selects) the physical layer parameter(s) prior to monitoring for uplink signals. For example, in some implementations, the identification of a physical layer parameter comprises selecting the physical layer parameter based on at least one broadcast parameter used by the second access point (e.g., PSC, etc.). As another example, in some implementations, the access point may select a set of physical layer parameters to monitor (e.g., where the set is associated with a known set of information types that may be communicated to the access point via uplink signaling). As discussed above, the selection of the physical layer parameter(s) by a target access point may correspond to the selection of the physical layer parameter(s) by the source access point based on a known association (e.g., mapping) of each physical layer parameter to, for example, a broadcast parameter (and, optionally, to a type of information to be communicated).

In some aspects, the access point may identify a physical layer parameter in conjunction with processing detected uplink signals. For example, in some implementations, the identification of the physical layer parameter comprises a search procedure wherein a received signal is decoded using different physical layer parameters to identify the physical layer parameter that successfully decodes the received signal. Thus, upon detection of a signal, the access point will attempt to decode the signal using successive ones of a set of physical layer parameters, until the physical layer parameter that successfully decodes the signal is found. Here, the set of physical layer parameters may be associated with a known set of information types that may be communicated to the access point via uplink signaling. In addition, or in the alternative, the set of physical layer parameters may be associated with a broadcast parameter used by the access point.

As represented by block 704, the access point uses the physical layer parameter to receive the uplink signal from the access terminal. For example, the access point may use a selected UL SC to determine whether there is an access terminal transmitting a signal using that UL SC.

As represented by block 706, the access point selects at least one operation to be performed based on the identified physical layer parameter. The access point then performs the selected operation(s). These operations may correspond to the operations listed herein or other suitable operations. For example, the at least one operation may comprise adjusting a transmit power, changing at least one broadcast parameter, transmitting on another channel, changing an access restriction or mode, sending a message, turning off, rebooting, or accepting specified messages via a backhaul.

In a typical implementation, upon receipt of a signal based on a particular physical layer parameter, the access point performs an operation or operations associated with (e.g., via a mapping) that physical layer parameter. For example, receipt of a signal based on UL SC-24 may cause the access point to increase its transmit power (e.g., by a defined power increment).

In an alternative implementation, the signal comprises a message including information from the source access point that is serving the access terminal. As discussed above, in this case, the selection of the at least one operation is based, at least in part, on the type of information received via the message. For example, receipt of information requesting an adjustment in transmit power may cause the access point to adjust its transmit power.

FIG. 8 illustrates several sample components (represented by corresponding blocks) that may be incorporated into an apparatus 802 and an apparatus 804 (e.g., corresponding to the access point 106 and the access terminal 104 of FIG. 1, respectively) to perform communication operations as taught herein. It should be appreciated that these components may be implemented in different types of apparatuses in different implementations (e.g., in an ASIC, in a system on a chip (SoC), etc.). The described components also may be incorporated into other apparatuses in a communication system. For example, other apparatuses in a system may include components similar to those described for the apparatus 802 to provide similar functionality. Also, a given apparatus may contain one or more of the described components. For example, an apparatus may include multiple transceiver components that enable the apparatus to operate on multiple carriers and/or communicate via different technologies.

The apparatus 802 and the apparatus 804 each include at least one wireless communication device (represented by the communication devices 806 and 808, respectively) for communicating with other nodes via at least one designated radio access technology. Each communication device 806 includes at least one transmitter (represented by the transmitter 810) for sending signals (e.g., messages, indications, information, pilots, and so on) and at least one receiver (represented by the receiver 812) for receiving signals (e.g., messages, indications, information, uplink signals, and so on). Similarly, each communication device 808 includes at least one transmitter (represented by the transmitter 814) for sending signals (e.g., messages, indications, information, uplink signals, and so on) and at least one receiver (represented by the receiver 816) for receiving signals (e.g., messages, indications, information, pilots, and so on). In some aspects, the communication device 806 may be configured to perform one or more of: invoking communication by sending (e.g., transmitting) a message to an access terminal, receiving a message from an access terminal, sending another message, or using a physical layer parameter to receive a signal. In some aspects, the communication device 808 may be configured to perform one or more of: receiving a message from an access point; sending (e.g., transmitting) uplink signaling, conducting measurements, or sending measurement reports. A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 802 comprises a network listen module.

The apparatus 802 includes at least one communication device (represented by the communication device 818) for communicating with other nodes. For example, the communication device 818 may comprise a network interface that is configured to communicate with one or more network entities via a wire-based or wireless backhaul. In some aspects, the communication device 818 may be implemented as a transceiver configured to support wire-based or wireless signal communication. This communication may involve, for example, sending and receiving: messages, parameters, or other types of information. Accordingly, in the example of FIG. 8, the communication device 818 is shown as comprising a transmitter 820 and a receiver 822.

The apparatus 802 and the apparatus 804 also include other components that may be used in conjunction with communication operations as taught herein. The apparatus 802 includes a processing system 824 for providing functionality relating to invoking uplink signaling by an access terminal and for providing other processing functionality. For example, the processing system 824 may perform at least one of: determining that a first access point is to communicate uplink transmissions by an access terminal; selecting a physical layer parameter for the uplink transmissions; identifying a physical layer parameter for receiving a signal from an access terminal that is not being served by the access point; or selecting at least one operation to be performed at the access point based on the identified physical layer parameter. In addition, the apparatus 804 includes a processing system 826 for providing functionality relating to relaying information and for providing other processing functionality. The processing system 826 may perform at least one of: determining to transmit uplink signaling using a specified physical layer parameter as a result of receiving a message from an access point, or including information received in conjunction with the message in the uplink signaling. The apparatus 802 and the apparatus 804 include memory components 828 and 830 (e.g., each including a memory device), respectively, for maintaining information (e.g., information, thresholds, parameters, and so on). In addition, the apparatus 802 and the apparatus 804 include user interface devices 832 and 834, respectively, for providing indications (e.g., audible and/or visual indications) to a user and/or for receiving user input (e.g., upon user actuation of a sensing device such a keypad, a touch screen, a microphone, and so on).

For convenience the apparatus 802 is shown in FIG. 8 as including components that may be used in the various examples described herein. In practice, the illustrated blocks may have different functionality in different aspects. For example, the functionality of the block 824 for performing the operations of FIG. 6 may be different as compared to the functionality for performing the operations of FIG. 7.

The components of FIG. 8 may be implemented in various ways. In some implementations the components of FIG. 8 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 806, 818, 824, 828, and 832 may be implemented by processor and memory component(s) of the apparatus 802 (e.g., by execution of appropriate code and/or by appropriate configuration of processor components). Similarly, some or all of the functionality represented by blocks 808, 826, 830, and 834 may be implemented by processor and memory component(s) of the apparatus 806 (e.g., by execution of appropriate code and/or by appropriate configuration of processor components).

As discussed above, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNodeB, macrocell, and so on. Also, a femto access point may be configured or referred to as a Home NodeB, Home eNodeB, access point base station, femtocell, and so on. In some implementations, a node may be associated with (e.g., referred to as or divided into) one or more cells or sectors. A cell or sector associated with a macro access point, a femto access point, or a pico access point may be referred to as a macrocell, a femtocell, or a pico cell, respectively.

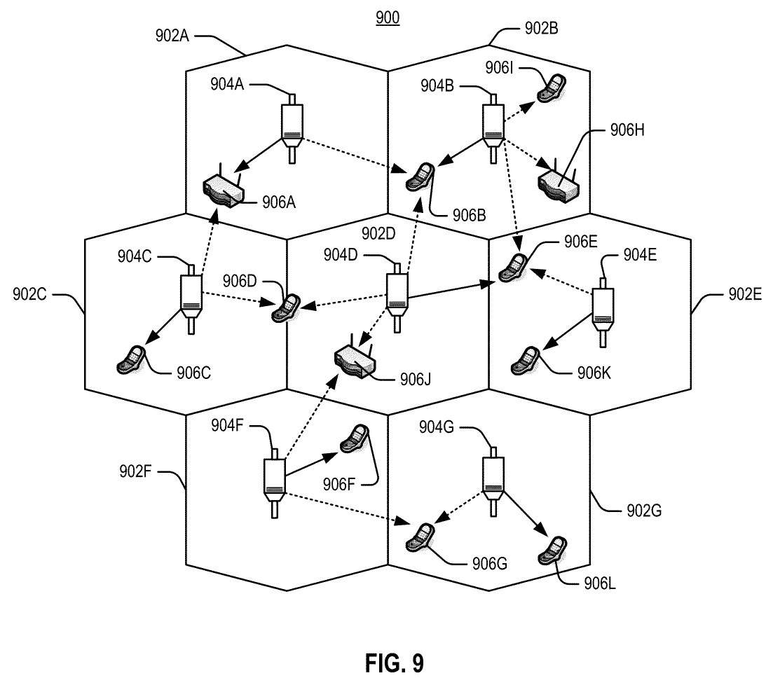

FIG. 9 illustrates a wireless communication system 900, configured to support a number of users, in which the teachings herein may be implemented. The system 900 provides communication for multiple cells 902, such as, for example, macrocells 902A-902G, with each cell being serviced by a corresponding access point 904 (e.g., access points 904A-904G). As shown in FIG. 9, access terminals 906 (e.g., access terminals 906A-906L) may be dispersed at various locations throughout the system over time. Each access terminal 906 may communicate with one or more access points 904 on a forward link (FL) and/or a reverse link (RL) at a given moment, depending upon whether the access terminal 906 is active and whether it is in soft handoff, for example. The wireless communication system 900 may provide service over a large geographic region. For example, macrocells 902A-902G may cover a few blocks in a neighborhood or several miles in a rural environment.

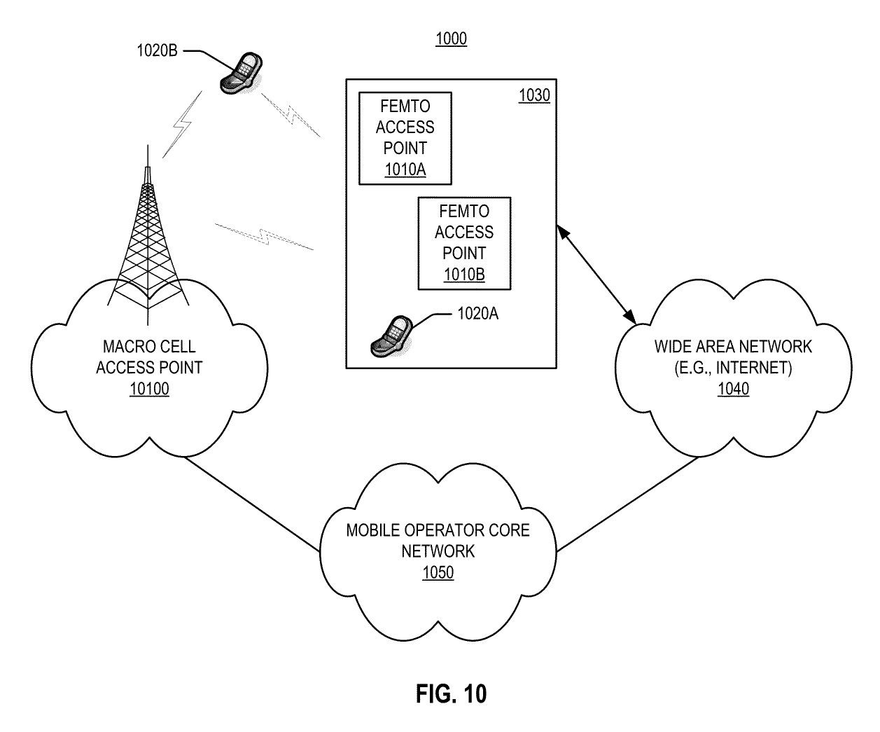

FIG. 10 illustrates an exemplary communication system 1000 where one or more femto access points are deployed within a network environment. Specifically, the system 1000 includes multiple femto access points 1010 (e.g., femto access points 1010A and 1010B) installed in a relatively small scale network environment (e.g., in one or more user residences 1030). Each femto access point 1010 may be coupled to a wide area network 1040 (e.g., the Internet) and a mobile operator core network 1050 via a DSL router, a cable modem, a wireless link, or other connectivity means (not shown). As will be discussed below, each femto access point 1010 may be configured to serve associated access terminals 1020 (e.g., access terminal 1020A) and, optionally, other (e.g., hybrid or alien) access terminals 1020 (e.g., access terminal 1020B). In other words, access to femto access points 1010 may be restricted whereby a given access terminal 1020 may be served by a set of designated (e.g., home) femto access point(s) 1010 but may not be served by any non-designated femto access points 1010 (e.g., a neighbor's femto access point 1010).

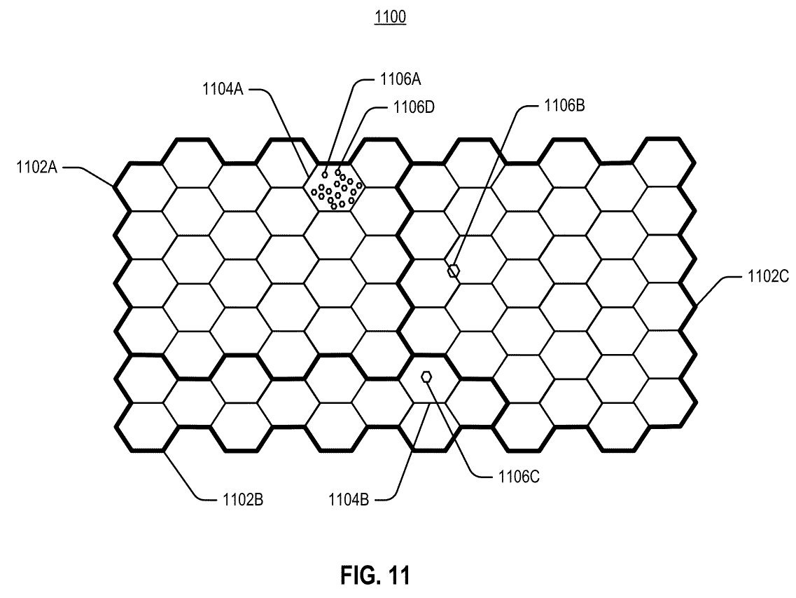

FIG. 11 illustrates an example of a coverage map 1100 where several tracking areas 1102 (or routing areas or location areas) are defined, each of which includes several macro coverage areas 1104. Here, areas of coverage associated with tracking areas 1102A, 1102B, and 1102C are delineated by the wide lines and the macro coverage areas 1104 are represented by the larger hexagons. The tracking areas 1102 also include femto coverage areas 1106. In this example, each of the femto coverage areas 1106 (e.g., femto coverage areas 1106B and 1106C) is depicted within one or more macro coverage areas 1104 (e.g., macro coverage areas 1104A and 1104B). It should be appreciated, however, that some or all of a femto coverage area 1106 might not lie within a macro coverage area 1104. In practice, a large number of femto coverage areas 1106 (e.g., femto coverage areas 1106A and 1106D) may be defined within a given tracking area 1102 or macro coverage area 1104. Also, one or more pico coverage areas (not shown) may be defined within a given tracking area 1102 or macro coverage area 1104.

Referring again to FIG. 10, the owner of a femto access point 1010 may subscribe to mobile service, such as, for example, 3G mobile service, offered through the mobile operator core network 1050. In addition, an access terminal 1020 may be capable of operating both in macro environments and in smaller scale (e.g., residential) network environments. In other words, depending on the current location of the access terminal 1020, the access terminal 1020 may be served by a macrocell access point 1060 associated with the mobile operator core network 1050 or by any one of a set of femto access points 1010 (e.g., the femto access points 1010A and 1010B that reside within a corresponding user residence 1030). For example, when a subscriber is outside his home, he is served by a standard macro access point (e.g., access point 1060) and when the subscriber is at home, he is served by a femto access point (e.g., access point 1010A). Here, a femto access point 1010 may be backward compatible with legacy access terminals 1020.

A femto access point 1010 may be deployed on a single frequency or, in the alternative, on multiple frequencies. Depending on the particular configuration, the single frequency or one or more of the multiple frequencies may overlap with one or more frequencies used by a macro access point (e.g., access point 1060).

In some aspects, an access terminal 1020 may be configured to connect to a preferred femto access point (e.g., the home femto access point of the access terminal 1020) whenever such connectivity is possible. For example, whenever the access terminal 1020A is within the user's residence 1030, it may be desired that the access terminal 1020A communicate only with the home femto access point 1010A or 1010B.

In some aspects, if the access terminal 1020 operates within the macro cellular network 1050 but is not residing on its most preferred network (e.g., as defined in a preferred roaming list), the access terminal 1020 may continue to search for the most preferred network (e.g., the preferred femto access point 1010) using a better system reselection (BSR) procedure, which may involve a periodic scanning of available systems to determine whether better systems are currently available and subsequently acquire such preferred systems. The access terminal 1020 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 1010, the access terminal 1020 selects the femto access point 1010 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macrocell mobile network and a defined set of femto access points (e.g., the femto access points 1010 that reside within the corresponding user residence 1030). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e g , limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

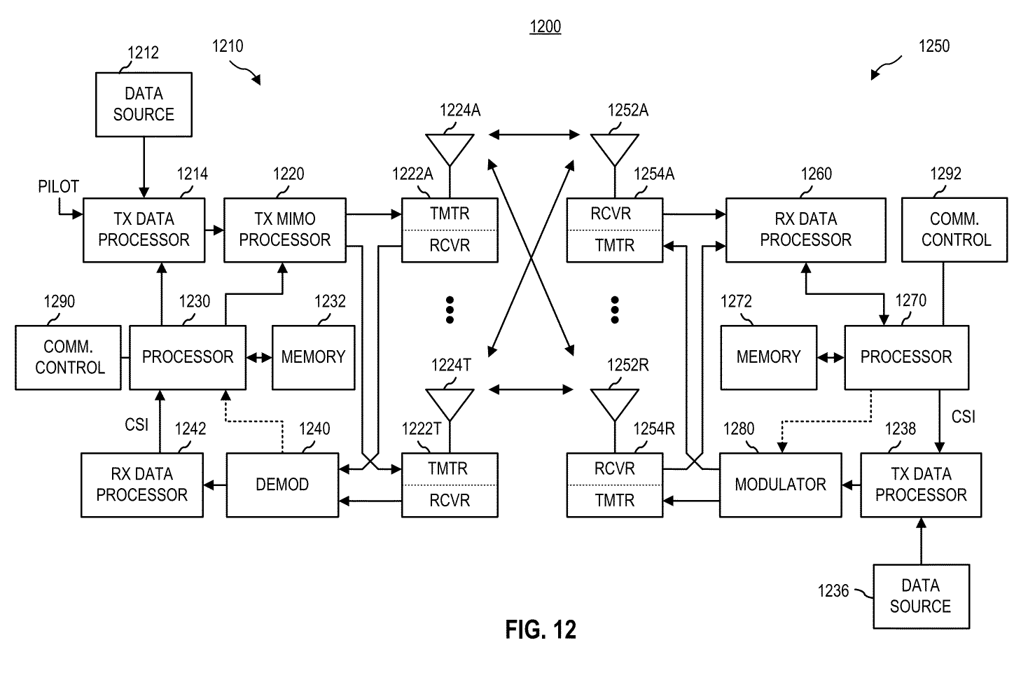

FIG. 12 illustrates a wireless device 1210 (e.g., an access point) and a wireless device 1250 (e.g., an access terminal) of a sample MIMO system 1200. At the device 1210, traffic data for a number of data streams is provided from a data source 1212 to a transmit (TX) data processor 1214. Each data stream may then be transmitted over a respective transmit antenna.

The TX data processor 1214 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1230. A data memory 1232 may store program code, data, and other information used by the processor 1230 or other components of the device 1210.

The modulation symbols for all data streams are then provided to a TX MIMO processor 1220, which may further process the modulation symbols (e.g., for OFDM). The TX MIMO processor 1220 then provides N_{T} modulation symbol streams to N_{T} transceivers (XCVR) 1222A through 1222T. In some aspects, the TX MIMO processor 1220 applies beam-forming weights to the symbols of the data streams and to the antenna from which the symbol is being transmitted.

Each transceiver 1222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1222A through 1222T are then transmitted from N_{T} antennas 1224A through 1224T, respectively.

At the device 1250, the transmitted modulated signals are received by N_{R} antennas 1252A through 1252R and the received signal from each antenna 1252 is provided to a respective transceiver (XCVR) 1254A through 1254R. Each transceiver 1254 conditions (e.g., filters, amplifies, and downconverts) a respective received signal, digitizes the conditioned signal to provide samples, and further processes the samples to provide a corresponding “received” symbol stream.

A receive (RX) data processor 1260 then receives and processes the N_{R} received symbol streams from N_{R} transceivers 1254 based on a particular receiver processing technique to provide N_{T} “detected” symbol streams. The RX data processor 1260 then demodulates, deinterleaves, and decodes each detected symbol stream to recover the traffic data for the data stream. The processing by the RX data processor 1260 is complementary to that performed by the TX MIMO processor 1220 and the TX data processor 1214 at the device 1210.

A processor 1270 periodically determines which pre-coding matrix to use (discussed below). The processor 1270 formulates a reverse link message comprising a matrix index portion and a rank value portion. A data memory 1272 may store program code, data, and other information used by the processor 1270 or other components of the device 1250.

The reverse link message may comprise various types of information regarding the communication link and/or the received data stream. The reverse link message is then processed by a TX data processor 1238, which also receives traffic data for a number of data streams from a data source 1236, modulated by a modulator 1280, conditioned by the transceivers 1254A through 1254R, and transmitted back to the device 1210.

At the device 1210, the modulated signals from the device 1250 are received by the antennas 1224, conditioned by the transceivers 1222, demodulated by a demodulator (DEMOD) 1240, and processed by a RX data processor 1242 to extract the reverse link message transmitted by the device 1250. The processor 1230 then determines which pre-coding matrix to use for determining the beam-forming weights then processes the extracted message.

FIG. 12 also illustrates that the communication components may include one or more components that perform communication (COMM.) control operations as taught herein. For example, a communication control component 1290 may cooperate with the processor 1230 and/or other components of the device 1210 to invoke another device (e.g., device 1250) to transmit on an uplink as taught herein. Similarly, a communication control component 1292 may cooperate with the processor 1270 and/or other components of the device 1250 to convey signals to/from another device (e.g., device 1210) as taught herein. It should be appreciated that for each device 1210 and 1250 the functionality of two or more of the described components may be provided by a single component. For example, a single processing component may provide the functionality of the communication control component 1290 and the processor 1230 and a single processing component may provide the functionality of the communication control component 1292 and the processor 1270.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1xRTT, 1xEV-DO Re10, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macrocell, a macro node, a Home eNB (HeNB), a femtocell, a femto node, a pico node, or some other similar terminology.

In some aspects, a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects, the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

The functionality described herein (e.g., with regard to one or more of the accompanying figures) may correspond in some aspects to similarly designated “means for” functionality in the appended claims.

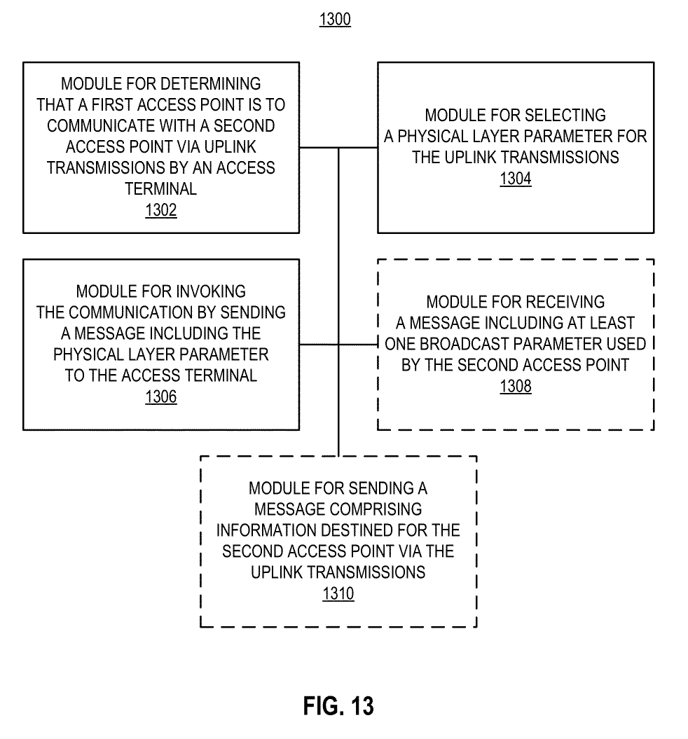

Referring to FIG. 13, an apparatus 1300 is represented as a series of interrelated functional modules. Here, a module for determining that a first access point is to communicate with a second access point via uplink transmissions by an access terminal 1302 may correspond at least in some aspects to, for example, a processing system as discussed herein. A module for selecting a physical layer parameter for the uplink transmissions 1304 may correspond at least in some aspects to, for example, a processing system as discussed herein. A module for invoking the communication by sending a message including the physical layer parameter to the access terminal 1306 may correspond at least in some aspects to, for example, a communication device as discussed herein. A module for receiving a message including at least one broadcast parameter used by the second access point 1308 may correspond at least in some aspects to, for example, a communication device as discussed herein. A module for sending a message comprising information destined for the second access point via the uplink transmissions 1310 may correspond at least in some aspects to, for example, a communication device as discussed herein.

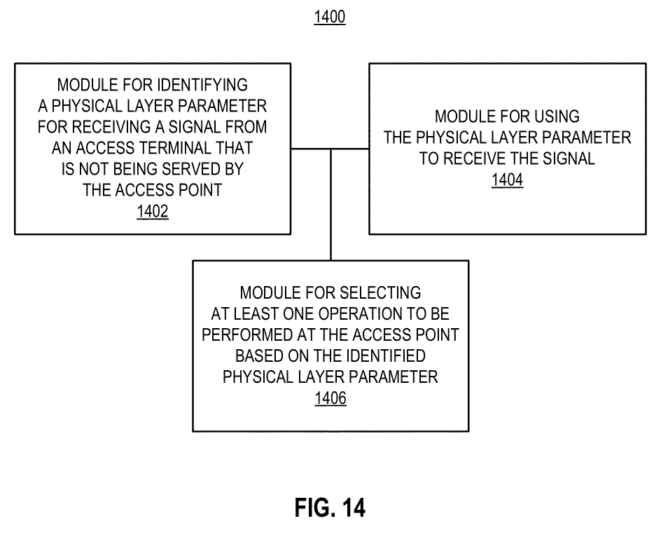

Referring to FIG. 14, an apparatus 1400 is represented as a series of interrelated functional modules. Here, a module for identifying a physical layer parameter for receiving a signal from an access terminal that is not being served by the access point 1402 may correspond at least in some aspects to, for example, a processing system as discussed herein. A module for using the physical layer parameter to receive the signal 1404 may correspond at least in some aspects to, for example, a communication device as discussed herein. A module for selecting at least one operation to be performed at the access point based on the identified physical layer parameter 1406 may correspond at least in some aspects to, for example, a processing system as discussed herein.

The functionality of the modules of FIGS. 13 and 14 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. As one specific example, the apparatus 1400 may comprise a single device (e.g., components 1402-1406 comprising different sections of an ASIC). As another specific example, the apparatus 1400 may comprise several devices (e.g., the component 1402 comprising one ASIC and the components 1404-1406 comprising another ASIC). The functionality of these modules also may be implemented in some other manner as taught herein. In some aspects one or more of any dashed blocks in FIGS. 13 and 14 are optional.

In addition, the components and functions represented by FIGS. 13 and 14 as well as other components and functions described herein, may be implemented using any suitable means. Such means also may be implemented, at least in part, using corresponding structure as taught herein. For example, the components described above in conjunction with the “module for” components of FIGS. 13 and 14 also may correspond to similarly designated “means for” functionality. Thus, in some aspects one or more of such means may be implemented using one or more of processor components, integrated circuits, or other suitable structure as taught herein. Several examples follow. In some aspects, means for determining comprises a processing system. In some aspects, means for selecting comprises a processing system. In some aspects, means for invoking comprises a communication device. In some aspects, means for receiving comprises a receiver or communication device. In some aspects, means for transmitting comprises a transmitter or communication device. In some aspects, means for identifying comprises a processing system. In some aspects, means for using comprises a receiver or communication device.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code(s) executable (e.g., executable by at least one computer) to provide functionality relating to one or more of the aspects of the disclosure. In some aspects, a computer program product may comprise packaging materials.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a processing system configured to:
determine that a first access point is to communicate with a second access point via uplink transmissions by an access terminal served by the first access point, and
select, as a result of the determination, a physical layer parameter for the uplink transmissions by the access terminal; and
a communication device configured to invoke the communication by sending a message from the first access point to the access terminal, wherein the message includes the physical layer parameter.

2. The apparatus of claim 1, wherein the physical layer parameter is an uplink scrambling code or a random access channel (RACH) physical layer parameter.

3. The apparatus of claim 1, wherein the selection of the physical layer parameter is based on at least one broadcast parameter used by the second access point.

4. The apparatus of claim 3, wherein the at least one broadcast parameter comprises at least one of: a primary scrambling code, a physical cell identity, a cell identifier, a location area code, a tracking area code, or a routing area code.

5. The apparatus of claim 3, wherein:
the communication device is further configured to receive another message;
the other message is received from the access terminal;
the other message indicates that the second access point has been detected by the access terminal; and
the other message includes the at least one broadcast parameter.

6. The apparatus of claim 1, wherein the determination that the first access point is to communicate with the second access point comprises identifying a type of information to be communicated.

7. The apparatus of claim 6, wherein the selection of the physical layer parameter is based on the identified type of information.

8. The apparatus of claim 6, wherein the identified type of information comprises a cell identifier of the first access point.

9. The apparatus of claim 6, wherein the identified type of information specifies at least one operating condition at the first access point.

10. The apparatus of claim 9, wherein the at least one operating condition comprises at least one of: load information for the first access point; at least one capability supported by the first access point; availability of at least one resource of the first access point; or an alarm condition at the first access point.

11. The apparatus of claim 6, wherein the identified type of information comprises an indication of physical layer identifier confusion in a neighborhood of the first access point.

12. The apparatus of claim 6, wherein the identified type of information comprises at least one request to the second access point.

13. The apparatus of claim 12, wherein the at least one request to the second access point comprises at least one of: a request to change at least one parameter at the second access point, a request to turn off the second access point, a request to reboot the second access point, a request to accept handover of an access terminal, or a request to commence transmission on a specified channel.

14. The apparatus of claim 13, wherein the at least one parameter relates to at least one of: a primary scrambling code (PSC), a physical cell identity (PCI), a random access channel (RACH) parameter, a location area code (LAC), a routing area code (RAC), a tracking area code (TAC), a closed subscriber group identifier (CSG ID), a CSG Indicator, a SIB schedule, invoking transmission of an additional SIB, a transmit power, an access restriction, or an access mode.

15. The apparatus of claim 1, wherein:
the communication device is further configured to send another message from the first access point to the access terminal; and
the other message comprises information destined for the second access point via the uplink transmissions by the access terminal.

16. The apparatus of claim 15, wherein the information comprises at least one of:
load information for the first access point;
at least one capability supported by the first access point;
availability of at least one resource of the first access point;
an alarm indication at the first access point;
an indication of physical layer identifier confusion in a neighborhood of the first access point;
a request to change at least one parameter at the second access point;
a request to turn off the second access point;
a request to reboot the second access point;
a request to accept handover of an access terminal; or
a request to commence transmission on a specified channel.

17. A method of communication, comprising:
determining that a first access point is to communicate with a second access point via uplink transmissions by an access terminal served by the first access point;
selecting, as a result of the determination, a physical layer parameter for the uplink transmissions by the access terminal; and
invoking the communication by sending a message from the first access point to the access terminal, wherein the message includes the physical layer parameter.

18. The method of claim 17, wherein the physical layer parameter is an uplink scrambling code or a random access channel (RACH) physical layer parameter.

19. The method of claim 17, wherein the selection of the physical layer parameter is based on at least one broadcast parameter used by the second access point.

20. The method of claim 19, wherein the at least one broadcast parameter comprises at least one of: a primary scrambling code, a physical cell identity, a cell identifier, a location area code, a tracking area code, or a routing area code.

21. The method of claim 19, wherein:
the method further comprises receiving another message;
the other message is received from the access terminal;
the other message indicates that the second access point has been detected by the access terminal; and
the other message includes the at least one broadcast parameter.

22. The method of claim 17, wherein the determination that the first access point is to communicate with the second access point comprises identifying a type of information to be communicated.

23. The method of claim 22, wherein the selection of the physical layer parameter is based on the identified type of information.

24. The method of claim 22, wherein the identified type of information comprises a cell identifier of the first access point.

25. The method of claim 22, wherein the identified type of information specifies at least one operating condition at the first access point.

26. The method of claim 25, wherein the at least one operating condition comprises at least one of: load information for the first access point; at least one capability supported by the first access point; availability of at least one resource of the first access point; or an alarm condition at the first access point.

27. The method of claim 22, wherein the identified type of information comprises an indication of physical layer identifier confusion in a neighborhood of the first access point.

28. The method of claim 22, wherein the identified type of information comprises at least one request to the second access point.

29. The method of claim 28, wherein the at least one request to the second access point comprises at least one of: a request to change at least one parameter at the second access point, a request to turn off the second access point, a request to reboot the second access point, a request to accept handover of an access terminal, or a request to commence transmission on a specified channel.

30. The method of claim 29, wherein the at least one parameter relates to at least one of: a primary scrambling code (PSC), a physical cell identity (PCI), a random access channel (RACH) parameter, a location area code (LAC), a routing area code (RAC), a tracking area code (TAC), a closed subscriber group identifier (CSG ID), a CSG Indicator, a SIB schedule, invoking transmission of an additional SIB, a transmit power, an access restriction, or an access mode.

31. The method of claim 17, wherein:
the method further comprises sending another message from the first access point to the access terminal; and
the other message comprises information destined for the second access point via the uplink transmissions by the access terminal.

32. The method of claim 31, wherein the information comprises at least one of:
load information for the first access point;
at least one capability supported by the first access point;
availability of at least one resource of the first access point;
an alarm indication at the first access point;
an indication of physical layer identifier confusion in a neighborhood of the first access point;
a request to change at least one parameter at the second access point;
a request to turn off the second access point;
a request to reboot the second access point;
a request to accept handover of an access terminal; or
a request to commence transmission on a specified channel.

33. An apparatus for communication, comprising:
means for determining that a first access point is to communicate with a second access point via uplink transmissions by an access terminal served by the first access point;
means for selecting, as a result of the determination, a physical layer parameter for the uplink transmissions by the access terminal; and
means for invoking the communication by sending a message from the first access point to the access terminal, wherein the message includes the physical layer parameter.

34. The apparatus of claim 33, wherein the selection of the physical layer parameter is based on at least one broadcast parameter used by the second access point.

35. The apparatus of claim 34, further comprising means for receiving another message at the first access point, wherein:
the other message is received from the access terminal;
the other message indicates that the second access point has been detected by the access terminal; and
the other message includes the at least one broadcast parameter.

36. The apparatus of claim 33, wherein the determination that the first access point is to communicate with the second access point comprises identifying a type of information to be communicated.

37. The apparatus of claim 36, wherein the selection of the physical layer parameter is based on the identified type of information.

38. The apparatus of claim 33, further comprising means for sending another message from the first access point to the access terminal, wherein the other message comprises information destined for the second access point via the uplink transmissions by the access terminal

39. A computer-program product, comprising:
computer-readable medium comprising code for causing a computer to:
determine that a first access point is to communicate with a second access point via uplink transmissions by an access terminal served by the first access point;
select, as a result of the determination, a physical layer parameter for the uplink transmissions by the access terminal; and
invoke the communication by sending a message from the first access point to the access terminal, wherein the message includes the physical layer parameter.

40. The computer-program product of claim 39, wherein the selection of the physical layer parameter is based on at least one broadcast parameter used by the second access point.

41. The computer-program product of claim 40, wherein:
the computer-readable medium further comprises code for causing the computer to receive another message at the first access point;
the other message is received from the access terminal;
the other message indicates that the second access point has been detected by the access terminal; and
the other message includes the at least one broadcast parameter.

42. The computer-program product of claim 39, wherein the determination that the first access point is to communicate with the second access point comprises identifying a type of information to be communicated.

43. The computer-program product of claim 42, wherein the selection of the physical layer parameter is based on the identified type of information.

44. The computer-program product of claim 39, wherein:
the computer-readable medium further comprises code for causing the computer to send another message from the first access point to the access terminal; and
the other message comprises information destined for the second access point via the uplink transmissions by the access terminal.

45. An apparatus for communication, comprising:
a processing system configured to identify, at an access point, a physical layer parameter for receiving a signal from an access terminal that is not being served by the access point; and
a communication device configured to use the physical layer parameter to receive the signal,
wherein the processing system is further configured to select at least one operation to be performed at the access point based on the identified physical layer parameter.

46. The apparatus of claim 45, wherein the physical layer parameter is an uplink scrambling code or a random access channel (RACH) physical layer parameter.

47. The apparatus of claim 45, wherein the identification of the physical layer parameter comprises selecting the physical layer parameter based on at least one broadcast parameter used by the access point.

48. The apparatus of claim 47, wherein the at least one broadcast parameter comprises at least one of: a primary scrambling code, a cell identifier, a location area code, or a routing area code.

49. The apparatus of claim 45, wherein the identification of the physical layer parameter comprises decoding the received signal with different physical layer parameters to identify one of the physical layers parameters that successfully decodes the received signal.

50. The apparatus of claim 45, wherein the at least one operation comprises adjusting a transmit power of the access point.

51. The apparatus of claim 45, wherein the at least one operation comprises changing at least one broadcast parameter used by the access point.

52. The apparatus of claim 51, wherein the at least one broadcast parameter relates to at least one of: a primary scrambling code (PSC), a physical cell identity (PCI), a random access channel (RACH) parameter, a location area code (LAC), a routing area code (RAC), a tracking area code (TAC), a closed subscriber group identifier (CSG ID), a CSG Indicator, a SIB schedule, or invoking transmission of an additional SIB.

53. The apparatus of claim 45, wherein the at least one operation comprises transmitting on another channel.

54. The apparatus of claim 45, wherein the at least one operation comprises at least one of:
changing an access restriction of the access point;
changing an access mode of the access point;
sending a message to another access point;
turning off the access point;
rebooting the access point; or
accepting specified messages via a backhaul.

55. The apparatus of claim 54, wherein:
the sent message relates to changing a physical layer parameter;
the sent message relates to changing an upper layer parameter;
the sent message relates to acknowledging monitoring of uplink transmissions from the access terminal; and
the specified messages are handover-related messages.

56. The apparatus of claim 45, wherein:
the signal comprises a message including information from another access point that is serving the access terminal; and
the selection of the at least one operation is further based on the information.

57. The apparatus of claim 56, wherein the information comprises at least one of:
load information for the other access point;
at least one capability supported by the other access point;
availability of at least one resource of the other access point;
an alarm indication at the other access point;
an indication of physical layer identifier confusion in a neighborhood of the other access point;
a request to change at least one parameter at the access point;
a request to turn off the access point;
a request to reboot the access point;
a request to accept handover of an access terminal; or
a request to commence transmission on a specified channel.

58. The apparatus of claim 57, wherein the at least one parameter relates to at least one of: a primary scrambling code (PSC), a physical cell identity (PCI), a random access channel (RACH) parameter, a location area code (LAC), a routing area code (RAC), a tracking area code (TAC), a closed subscriber group identifier (CSG ID), a CSG Indicator, a SIB schedule, invoking transmission of an additional SIB, a transmit power, an access restriction, or an access mode.

59. A method of communication, comprising:
identifying, at an access point, a physical layer parameter for receiving a signal from an access terminal that is not being served by the access point;
using the physical layer parameter to receive the signal; and
selecting at least one operation to be performed at the access point based on the identified physical layer parameter.

60. The method of claim 59, wherein the physical layer parameter is an uplink scrambling code or a random access channel (RACH) physical layer parameter.

61. The method of claim 59, wherein the identification of the physical layer parameter comprises selecting the physical layer parameter based on at least one broadcast parameter used by the access point.

62. The method of claim 61, wherein the at least one broadcast parameter comprises at least one of: a primary scrambling code, a physical cell identity, a cell identifier, a location area code, a tracking area code, or a routing area code.

63. The method of claim 59, wherein the identification of the physical layer parameter comprises decoding the received signal with different physical layer parameters to identify one of the physical layers parameters that successfully decodes the received signal.

64. The method of claim 59, wherein the at least one operation comprises adjusting a transmit power of the access point.

65. The method of claim 59, wherein the at least one operation comprises changing at least one broadcast parameter used by the access point.

66. The method of claim 65, wherein the at least one broadcast parameter relates to at least one of: a primary scrambling code (PSC), a physical cell identity (PCI), a random access channel (RACH) parameter, a location area code (LAC), a routing area code (RAC), a tracking area code (TAC), a closed subscriber group identifier (CSG ID), a CSG Indicator, a SIB schedule, or invoking transmission of an additional SIB.

67. The method of claim 59, wherein the at least one operation comprises transmitting on another channel.

68. The method of claim 59, wherein the at least one operation comprises at least one of:
changing an access restriction of the access point;
changing an access mode of the access point;
sending a message to another access point;
turning off the access point;
rebooting the access point; or
accepting specified messages via a backhaul.

69. The method of claim 68, wherein:
the sent message relates to changing a physical layer parameter;
the sent message relates to changing an upper layer parameter;
the sent message relates to acknowledging monitoring of uplink transmissions from the access terminal; and
the specified messages are handover-related messages.

70. The method of claim 59, wherein:
the signal comprises a message including information from another access point that is serving the access terminal; and
the selection of the at least one operation is further based on the information.

71. The method of claim 70, wherein the information comprises at least one of:
load information for the other access point;
at least one capability supported by the other access point;
availability of at least one resource of the other access point;
an alarm indication at the other access point;
an indication of physical layer identifier confusion in a neighborhood of the other access point;
a request to change at least one parameter at the access point;
a request to turn off the access point;
a request to reboot the access point;
a request to accept handover of an access terminal; or
a request to commence transmission on a specified channel.

72. The method of claim 71, wherein the at least one parameter relates to at least one of: a primary scrambling code (PSC), a physical cell identity (PCI), a random access channel (RACH) parameter, a location area code (LAC), a routing area code (RAC), a tracking area code (TAC), a closed subscriber group identifier (CSG ID), a CSG Indicator, a SIB schedule, invoking transmission of an additional SIB, a transmit power, an access restriction, or an access mode.

73. An apparatus for communication, comprising:
means for identifying, at an access point, a physical layer parameter for receiving a signal from an access terminal that is not being served by the access point;
means for using the physical layer parameter to receive the signal; and
means for selecting at least one operation to be performed at the access point based on the identified physical layer parameter.

74. The apparatus of claim 73, wherein the identification of the physical layer parameter comprises selecting the physical layer parameter based on at least one broadcast parameter used by the access point.

75. The apparatus of claim 73, wherein the identification of the physical layer parameter comprises decoding the received signal with different physical layer parameters to identify one of the physical layers parameters that successfully decodes the received signal.

76. The apparatus of claim 73, wherein:
the signal comprises a message including information from another access point that is serving the access terminal; and
the selection of the at least one operation is further based on the information.

77. A computer-program product, comprising:
computer-readable medium comprising code for causing a computer to:
identify, at an access point, a physical layer parameter for receiving a signal from an access terminal that is not being served by the access point;
use the physical layer parameter to receive the signal; and
select at least one operation to be performed at the access point based on the identified physical layer parameter.

78. The computer-program product of claim 77, wherein the identification of the physical layer parameter comprises selecting the physical layer parameter based on at least one broadcast parameter used by the access point.

79. The computer-program product of claim 77, wherein the identification of the physical layer parameter comprises decoding the received signal with different physical layer parameters to identify one of the physical layers parameters that successfully decodes the received signal.

80. The computer-program product of claim 77, wherein:
the signal comprises a message including information from another access point that is serving the access terminal; and
the selection of the at least one operation is further based on the information.
